(19) United States
(12) Patent Application Publication
(10) Pub. No.: US 2003/0010061 A1
(43) Pub. Date: Jan. 16, 2003

(54) Methods and apparatuses related to the integration of an air separation unit and a glass facility

(76) Inventors: Bao Ha, San Ramon, CA (US); Thierry Legiret, Toussus Le Noble (FR)

Correspondence Address: THE MATTHEWS FIRM, Suite 1800, 1900 West Loop South, Houston, TX, 77027, US

(21) Appl. No.: 09/938,783

(22) Filed: Aug. 24, 2001

Related U.S. Application Data
(60) Provisional application No. 60/301,643, filed on Jun. 28, 2001.

(51) Int. Cl. C03B 18/20

(52) U.S. Cl. 65/32.5; 65/99.2; 65/134.4; 65/157

(57) ABSTRACT

The present invention generally relates the recovery of energy from a glass facility, such as a glass manufacturing facility and/or a float glass facility. Various embodiments of the present invention incorporate an air separation unit with a glass facility whereby energy may be recovered, generated, and/or conserved. In various embodiments, energy is recovered, generated, and/or conserved through hot expansion, mass flow increase, more efficient fuel consumption and/or the like.

### RELATED APPLICATION

This application claims priority from provisional application number 60/601,643 filed Jun. 28, 2001.

### TECHNICAL FIELD

The present invention generally relates to an integration of an air separation unit and a glass production facility, and improvements thereof related to energy savings, energy consumption, and/or energy recovery.

### BACKGROUND

As used herein, the term oxygen stream means and refers to a stream with an oxygen content greater than about 21% by volume. As used herein, the term nitrogen stream means and refers to a stream with a nitrogen content greater than about 80% by volume. As used herein, the term unit means and refers to a facility, production plant, plant, and the like. As used herein, the term air separation unit means and refers to a unit for the separation of air into its components and can include both cryogenic and non-cryogenic processes. As used herein, the term glass melting operations means and refers to melting of constituents of glass by processes, methods and apparatuses common in the art.

In the glass making process, raw materials such as recycled glass, sand, minerals and chemicals, commonly referred as batch materials, are heated and melted in the glass melting furnace at high temperature over 1000° C. to yield a molten glass. Gas fired furnaces are quite common in the industry. The details of the operation of a glass melting furnace and various techniques for operational improvement are described in various patents, such as U.S. Pat. Nos. 6,209,355; 6,250,916B1; 6,253,578; 6,264,466; 5,979,191; and 5,807,418. The molten glass may then be further processed in a forming sequence to yield the glass in an appropriate form for final use such as bottles, containers, windows, video screens, as is common in the art. Reference to FIG. 1a illustrates a prior art glass melting furnace 1. A mixture of air (2), fuel (4), and load (3) is fed, and combusted in the melting furnace 5 to bring the feed load to its melting point. Flue gas 6 of the furnace is discharged to the atmosphere, typically after some cooling and cleanup to remove particulates.

An example of a glass production process is a float glass process. Float glass processes are widely used in the manufacture of window flat panes and the like. As its name indicates, this process is typically characterized by the delivery of a sheet of molten glass on the surface of a bath of molten metal, such as tin. The molten glass is normally delivered from the broad surface of the continuous glass tank over a refractory lip and onto the molten bath. The ribbon of molten glass flows outwardly upon the molten bath until the force tending to cause the spreading and the force resisting the spreading have reached an equilibrium. The force tending to cause the spreading is represented by the thickness and density of the glass. The force resisting the spreading is represented by the surface tension and the radius of curvature of the glass. Prior art examples of processes and apparatuses used in the production of float glass are depicted in U.S. Pat. Nos. 6,089,043; 5,827,341; 3,083,551; 3,884,665; 3,338,696; and 3,853,523, the disclosures of which are fully incorporated herein by reference.

Now referring to FIG. 1b, an illustration of a prior art float glass facility, a general construction and/or arrangement of the general structures of a float glass facility 1′ may be seen. A mixture of air (2′), fuel (4′), and load (3′) is fed, and combusted in the melting furnace 5′ to bring the feed load to its melting point. Flue gas 6′ of the furnace is discharged to the atmosphere after some cooling and cleanup to remove particulates.

Molten glass produced in the melting furnace 5′ then flows and/or is conveyed to a float glass-forming chamber 8′ wherein a flat sheet of glass is formed by floating the molten glass over a bath of molten tin under an atmosphere of, typically, nitrogen and hydrogen mixture. In many prior art processes, hydrogen 9′ is fed to a nitrogen stream 10′ that is then fed to chamber 8′. However, float glass facilities are common in the art and various embodiments are possible for the configuration of a float glass facility as will be understood by those skilled in the art. Moreover, glass manufacturing facilities other than float glass facilities are common in the art and are similar in construction and operation as a float glass facility with a major difference being the absence of a float glass forming chamber. However, there is still a melting furnace.

Glass manufacturing plants (“gas facilities” and/or “gas plants”) consume significant quantities of industrial gases such as nitrogen (“N2”), hydrogen (“H2”), and also some helium (“He”) and silane. To accommodate the large quantities of nitrogen gas consumed in a glass facility there is usually an air separation unit located in the vicinity of a glass plant to supply the nitrogen and/or other gases.

The combustion taking place in the melting furnace produces some nitrous oxides (“NOx”) which are detrimental to the environment. Some studies have shown that NOx emissions are responsible for smog formation, acid rain, and the destruction of ozone in the lower atmosphere. Therefore, to a certain extent, NOx emissions are indirectly contributing to global warming. Many factors govern the NOx formation in the combustion process such as flame temperature, nitrogen compounds in fuels, excess air, spatial/retention time in flame zone etc.

Recently, because of higher fuel cost and stricter regulations of NOx emission regulations, the glass industry is converting from an air-based combustion to an oxygen-based combustion to improve the furnace efficiency and to implement the NOx abatement. Air-based combustion results in a large volume of flue gas flow due to the nitrogen of the combustion air. This high volume of flue gas flow at high temperature is detrimental to the fuel efficiency of the furnace. Indeed, even with heat recovery equipment designed to preheat the combustion air against the exhaust flue gas to improve the fuel consumption, the extent of this heat recovery is fairly limited because of the presence of fouling materials in the flue gas that can solidify if the flue gas temperature is decreased below a certain level. This undesirable fouling occurs on the surface of the recovery heat exchanger causing plugging, reduction in performance and requiring shutdown for cleaning. Traditional glass furnaces are sometimes equipped with large regenerators filled with refractory materials or heat absorbing media such as brick, pebble, stone etc. Two regenerators are needed: one heated by flue gas, the other cooled by incoming combustion air. By alternating the regenerators between cooling and heating one can achieve some heat recovery of the flue gas. Because of the low pressure drop required for the flue gas, the size of the regenerators is significant and results in important space requirement and equipment cost. At the end of a campaign, the regenerators are partially plugged with deposits such that reduction in glass output is needed to avoid back pressure on the furnace. In most situations, the flue gas also contains some toxic chemicals, dust or particles that need to be removed by quenchers, scrubbers, electrostatic precipitators or bag-houses before discharging to atmosphere. This pollution abatement can be quite expensive for high flue gas flow rate of the air-based combustion process. The oxygen-based combustion, by reducing or eliminating the nitrogen in the oxidant, can reduce the flue gas flow drastically and improve significantly the fuel efficiency of the furnace. The gain in fuel efficiency will partially offset the added cost of the energy consumption associated with the production of oxygen required for the combustion. The resulting lower flow rate of the flue gas will alleviate the difficulties and cost associated with the downstream pollution control equipment.

Therefore, in addition to the industrial gases mentioned above, it has become necessary to supply gaseous oxygen (“O2”) to the combustion furnace of a glass facility. Typical nitrogen requirements for a 500 tonnes per day float glass facility is only about 50 tonnes per day in the float glass-forming chamber but requirements of as high as 250 tonnes per day of oxygen would be needed for the oxy-combustion process in the melting furnace of the float glass facility or a melting furnace of another type of glass facility. In terms of plant size based on air flow treated in a cryogenic cold box, the switch from air combustion to oxygen based combustion corresponds to a tenfold increase in air flow. Typical requirements for other glass facilities are well known in the art.

The power consumption of the oxygen plant is obviously the main concern when moving to the oxygen-based combustion process. Consequently, efforts are needed to reduce or minimize the power consumption of the oxygen plant so that the efficiency improvement and pollution abatement effort do not add an excessive cost to the final glass product.

There have been a variety of prior art solutions designed to improve the operation of float glass facilities and other glass plants. A prior art example of a float glass facility improvement includes U.S. Pat. No. 5,888,265 to Bonaquist et al. (the '265 patent). The '265 patent discloses a process whereby the nitrogen/hydrogen protective atmosphere within the float glass forming chamber is withdrawn as it becomes contaminated and is reprocessed in a purification system wherein the contaminants are removed from the stream. The reprocessed stream is then fed back to the chamber for further use. Lower capital cost and lower power usage are achieved by recycling the reprocessed mixture of nitrogen and hydrogen.

Another similar prior art process is disclosed in U.S. Pat. No. 5,925,158 to Weber et al. (the '158 patent). The '158 patent discloses a process whereby energy is conserved in the processing and purification of the protective atmosphere over the float glass forming chamber. The process disclosed in this patent to purify the protective atmosphere consists of washing the withdrawn protective atmosphere with water to remove the contaminants and then treating the withdrawn protective atmosphere to remove the majority of the remaining water.

Other prior examples utilize the hot flue gas of the melting furnace. In common prior art techniques the combusted air or oxidant is preheated against this hot flue gas to improve the fuel economy of the furnace, however, as previously explained, the majority of this heat is still lost. This represents a waste of energy and can be corrected to improve the overall efficiency of the process.

The concept of recovering thermal heat by heating nitrogen then expanded nitrogen for recovering its energy is not new and has been described in several patent documents.

U.K. Pat. Specification 1455960 described the concept of heating nitrogen product by heat exchange with a flue gas generated by a steam boiler. Nitrogen is then work expanded to convert the heat energy into mechanical energy.

U.S. Pat. No. 5,076,837 to Rathbone et al. (the '837 patent) teaches utilizing the heat of a partial oxidation or chemical process, which process utilizes the oxygen product of the air separation, to heat up a pressurized nitrogen product stream of an air separation unit (ASU). The ‘heated product’ is then expanded to produce the power to drive the compressors of the ASU. The embodiments of the '837 patent teach and disclose using a hot gas, either product or waste, produced from the partial oxidation of natural gas to pre-heat the compressed nitrogen.

### SUMMARY OF THE INVENTION

Generally, the present invention relates to the recovery and/or conservation of energy from a glass facility. More particularly, the present invention relates to techniques of integrating an air separation unit with a glass facility. Even more particularly, the present invention, in an embodiment, relates to the recovery of energy by hot expanding a warmed process stream that is warmed by heat exchange with a flue gas from a process, such as a melting furnace

This summary is not intended to be a limitation with respect to the features of the invention as claimed, and this and other objects can be more readily observed and understood in the detailed description of the preferred embodiment and the claims.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1a is an illustration of an embodiment of a prior art glass production facility.

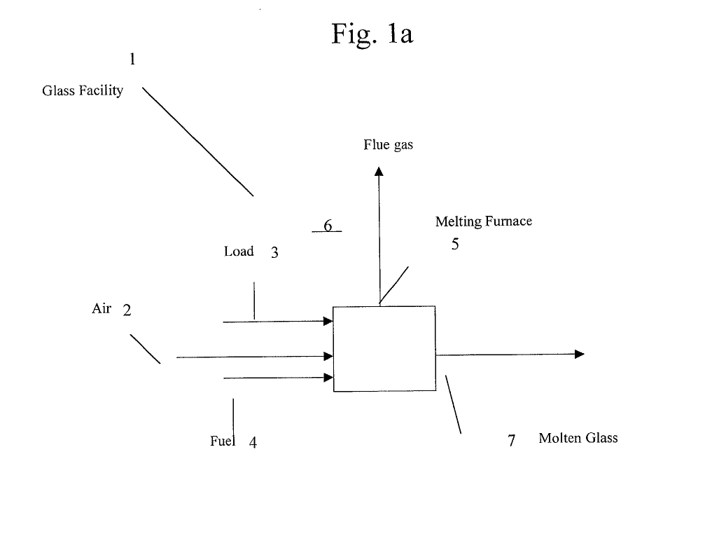

FIG. 1b is an illustration of an embodiment of a prior art float glass production facility.

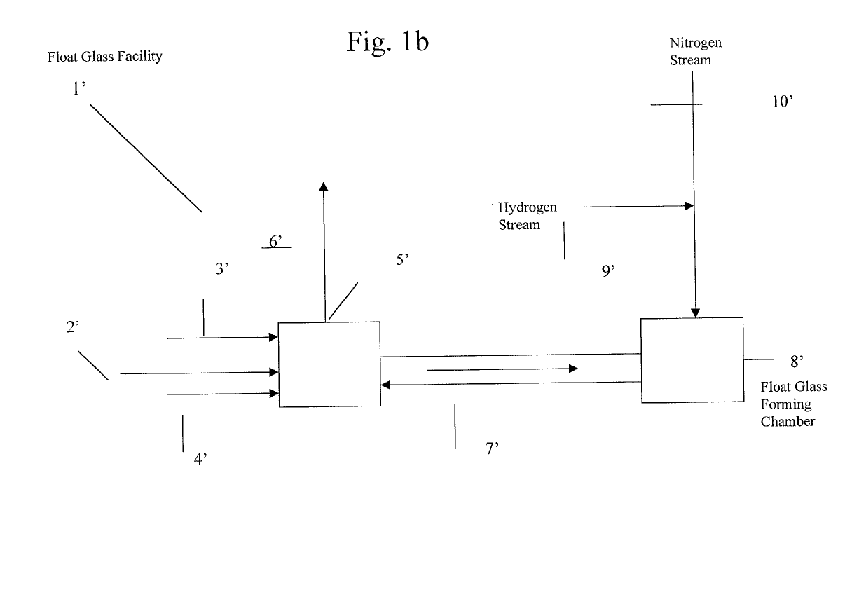

FIG. 2a is an illustration of an embodiment of an integrated air separation unit with a glass production facility of the present invention.

FIG. 2b is an illustration of an embodiment of an integrated air separation unit with a float glass production facility of the present invention.

FIG. 3 is an illustration of an alternate embodiment of an integrated air separation unit with a float glass production facility of the present invention.

FIG. 4 is an illustration of an embodiment of a single train to minimize equipment cost for an integrated air separation unit with a float glass production facility.

FIG. 5 is an illustration of an alternate embodiment of an integrated air separation unit with a float glass production facility of the present invention wherein the oxygen stream is preheated prior to introduction to the melting furnace.

FIG. 6 is an illustration of an alternate embodiment of the present invention wherein the oxygen stream is preheated with an alternate source of heat.

FIG. 7 is an illustration of an embodiment of an alternate energy recovery system that can be employed with the various embodiments of the present invention.

FIG. 8 is an illustration of an alternate embodiment of the present invention wherein the second nitrogen stream is preheated.

### DETAILED DESCRIPTION OF THE INVENTION

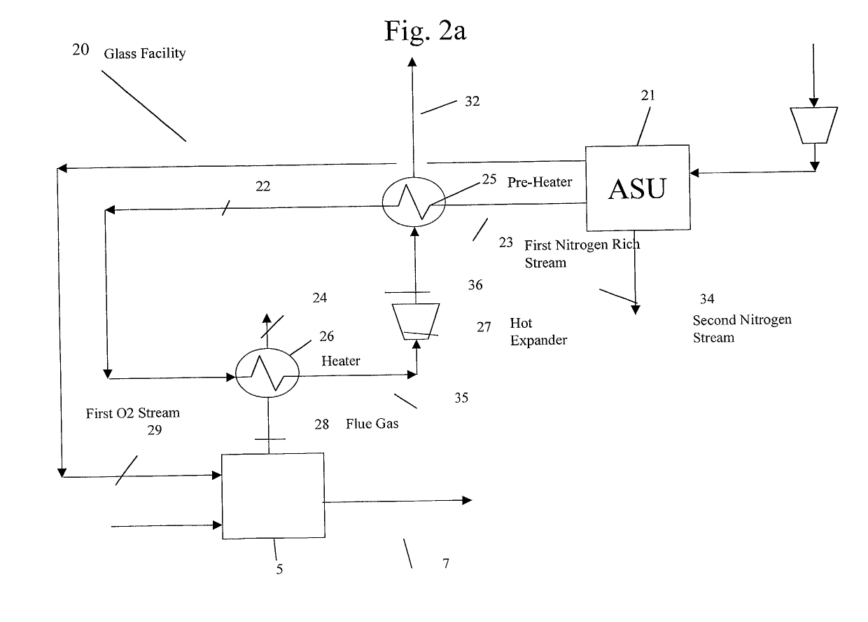

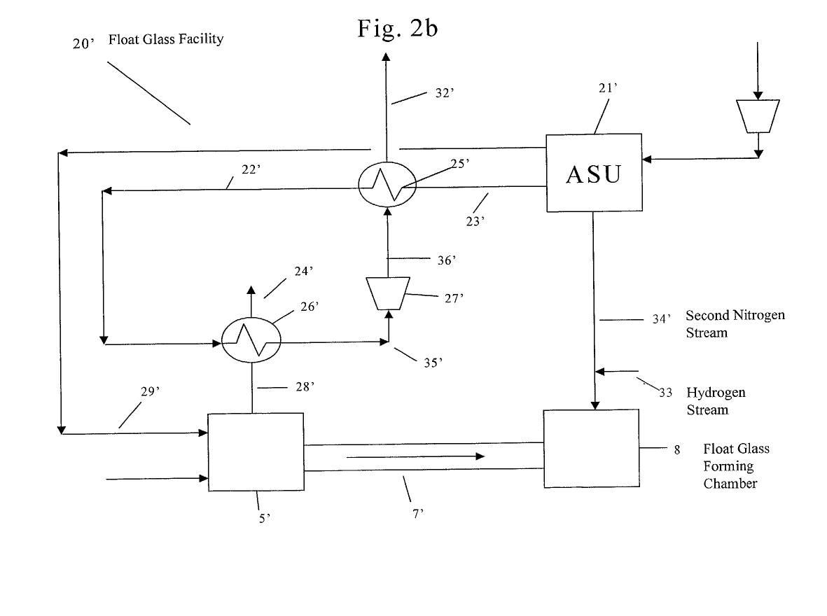

Now referring to FIG. 2a, the general concept of an embodiment of a combined air separation unit and glass facility 20 of the present invention is illustrated. In an embodiment, atmospheric air is treated cryogenically in an air separation unit (“ASU”) 21 to yield a first oxygen stream 29 that can be extracted and a first nitrogen stream 22 that can be extracted. A second nitrogen rich stream 34 may also be produced and extracted, in various embodiments. In other embodiments, various other process streams and/or numbers of process streams may be produced. In yet further embodiments, either of first nitrogen source or second nitrogen source may be supplied by alternate means, such as a liquid supply, pipeline, and/or the like. Reference to FIG. 2b a float glass facility is integrated with an ASU. Nitrogen stream 34′ may be fed to float glass forming chamber 8. Hydrogen stream 33 may be mixed with nitrogen stream 34 before feeding to chamber 8.

Referring back to FIG. 2a, an oxygen rich stream 29 can be withdrawn from the ASU and fed to melting furnace 5. Oxygen may be fed to melting furnace 5 at any pressure and in varied concentrations. In various embodiments, common prior art pressures of less than 2 bar absolute may be used. The oxygen content of the oxygen rich stream can be of any content greater than 21% by volume, and preferably between about 55% and about 100% by volume. In other embodiments, a combined oxy-fuel and air-fuel burners are used, as is common in the art.

It is well known that the combustion with enriched oxygen in conventional burners can cause significant increases in NOx emissions, especially with oxygen content between 30% and 70% molar, as discussed above. However, there are some significant cost savings associated with the cryogenic air separation process producing enriched oxygen at about 30% to 70% oxygen content. For example, relatively low cost nitrogen generators can be used to produce the enriched oxygen.

When operating the furnace with this kind of enriched oxygen, a lowNOx burner is usually needed and/or used. Modem gas burners with very low NOx formation have been used successfully for applications involved enriched oxygen or pure oxygen. Normally, when combusting pure oxygen, there will be very low NOx emission due to the lack of nitrogen molecules in the oxidant. However, pure oxygen utilized in the combustion process does contain some nitrogen and natural gas fuel can also have nitrogen content as high as 5-10%. Because of those reasons, along with non-negligible air leakage into the oxy-fuel combustion furnace, it is of common practice to use low-NOx burners wherever possible. There are several types of low-NOx burners designed to operate with enriched oxygen at concentrations higher than 21% oxygen content encountered with combustion of air. Numerous techniques can be used to minimize the NOx formation when combusting enriched oxygen with fuels. In one approach to minimize NOx formation, instead of pre-mixing the fuel and the oxidant, one can separate the flames into several stages, each stage will have its own fuel-rich characteristics such that the combined flame will meet the NOx emission requirement. The description of various types of low-NOx burners and their advantages over conventional burners can be found widely in published literature. For example, some patent documents related to low-NOx burners are U.S. Pat. Nos. 4,797,087; 5,308,239; 5,217,363; 5,611,683; 5,772,421; 5,846,067; 6,206,686; 6,267,586; and the like.

In various embodiments, an oxygen rich stream fed to melting furnace 5 is combusted with fuel to provide necessary heat for glass melting operations. Examples of fuels used with various embodiments of the present invention include natural gas and other hydrocarbons. However, any combustible fuel capable of heating melting furnace 5 sufficiently to melt the glass constituents can be used. After melting, molten glass 7 may be fed to a forming sequence to be shaped and/or processed into an end product, as is well-known in the art.

Now referring to FIG. 2b, in a float glass embodiment, molten glass 7′ is fed to a float glass forming chamber 8 wherein glass is produced. In an alternate embodiment, a second nitrogen product 34′ may be extracted from ASU 21 and fed with hydrogen 33 to chamber 8. This second nitrogen stream 34′ and the added hydrogen stream is used, among other reasons, to protect the glass as it is forming. In other embodiments of glass facilities, a second nitrogen stream may be extracted for another purpose, as is common in the art.

Various embodiments of the present invention incorporate a system, as disclosed in either of U.S. Pat. Nos. 5,925,158 and/or 5,888,265, the disclosures of which are incorporated herein by reference, to remove contaminants from the protective atmosphere. Many of the systems commonly available, including the ones cited, use a variety of absorbers, such as water, filters, and the like to remove the contaminants. As well, various other systems for contaminant removal are well known in the art.

Referring back to FIG. 2a, a flue gas 28 is discharged and/or extracted from melting furnace 5. Flue gas of the present invention is generally at a temperature of between about 1000 degrees Celsius to about 2000 degrees Celsius. In another embodiment, flue gas of the present invention is at a temperature of about 1200 degrees Celsius to about 1800 degrees Celsius. In another embodiment, flue gas of the present invention is at a temperature of about 1400 degrees Celsius to about 1600 degrees Celsius. In prior art gas facilities most of the heat contained in the flue gas is wasted. Various embodiments of the present invention recover at least a portion of this heat and convert it to electricity, and/or mechanical energy through any of a variety of energy recovery apparatuses, as are common in the art.

In an embodiment, a first nitrogen stream 23 is withdrawn from ASU 21. In various embodiments, the purity of nitrogen is at least about 80% by volume. In various other embodiments, the purity of nitrogen is at least about 90% by volume. In other embodiments, the purity of nitrogen is at least about 95% by volume to about 99.99% by volume.

First nitrogen stream is then passed through a heater 26. Heater 26 may be any heater common in the art, such as a heat exchanger or a furnace. Various embodiments utilize heat exchange with a flue gas of melting furnace 5 in the heater 26. Any heat exchanged in the art will operate under various embodiments of the present invention. Any exchanges that are common in the art, wherein, the two fluids exchange heat do not interact, and direct heat exchange, wherein, the 2 fluids exchanging heat contact one another in a regenerator. After heat exchange and/or other heating with first nitrogen stream, flue gas 24 may be discharged to the atmosphere. Various embodiments may further process and/or use the flue gas stream. Such further and other uses may include cleaning or further use(s) in a process, such as for an additional heater for a process stream and the like.

The first nitrogen stream can be heated to temperature between 200° C. and 1000° C., preferably between 400° C. and 800° C. The heating of first nitrogen stream can be performed in a single heat exchanger or a plurality of heat exchangers.

Optionally, first nitrogen stream may be heated in a pre-heater 25. In various embodiments, pre-heater 25 is heated by indirect heat exchange with expanded first 14 nitrogen stream. In other embodiments, pre-heater 25 is heated by any method, process or apparatus common in the art, such as a natural gas heater.

In other embodiments, after first nitrogen stream is heated in heater 26, first nitrogen stream is heat expanded in hot expander 27 for energy recovery. The energy recovered can be mechanical power, electric power, a combination of both, and/or the like. In various embodiments, at least a portion of the heat contained in the outlet stream 36 of the expander may be additionally recovered in pre-heater 25 to heat a desired product and/or process stream. In various embodiments, first nitrogen stream of the ASU is preheated in pre-heater 25 before being heated by heat exchanger 26.

Since the oxygen rich stream is used to improve the efficiency of the furnace and to meet NOx emission requirements of the combustion process, it is advantageous to produce an oxygen stream with relatively high oxygen content of at least about 90-93% by volume. However, as described previously, various embodiments of the present invention may utilize a low NOx burner. The use of a low NOx burner allows utilizing lower purity of oxygen and still meeting the requirement of low NOx emission. In various embodiments utilizing a low NOx burner, an oxygen content of about 30% to a volume of about 80% is utilized. However, any concentration of oxygen greater than 21% may be used. Accordingly, the oxygen content of the oxidant can therefore be selected from a wide range of oxygen content and/or purity to yield an optimum power consumption and equipment cost.

In various embodiments, ASU 21 can therefore be a nitrogen generator producing efficiently pressurized nitrogen and a high oxygen content waste stream of about 50% by volume to about 80% by volume. Prior art examples of suitable nitrogen generators with oxygen waste streams may be found in U.S. Pat. No. 4,717,410. However, suitable nitrogen generators for accomplishing the production of a sufficiently high pressure nitrogen stream and waste oxygen stream are known in the art and any of such processes and/or apparatuses may be used in the present invention. ASU 21 can also be an elevated pressure oxygen plant producing low purity oxygen at about 80% by volume or higher and a pressurized nitrogen product, for example the one described in U.S. Pat. No. 5,231,837. In some embodiments, ASU 21 can produce two (2) or more nitrogen streams at several (different or like) pressure levels and various product compressors can be used to compress those nitrogen streams to higher pressures before feeding the streams to hot gas expander 27 or before feeding to a hot gas expander circuit 35 or before using the products elsewhere. The pressure of the first nitrogen stream, prior to expansion, can be selected to provide an optimum operation of the expander(s). This pressure is usually of at least 2 bar absolute and preferably between 2 bar and 20 bar absolute. The persons skill in the art can select the optimum pressure level of this pressure, taken into account the additional energy expensed for any further compression and the gain in recovered power of the expander at higher pressure levels.

By recovering heat of the flue gas and/or expanding hot nitrogen to recover its energy, power consumption of the overall unit can be greatly reduced. Recovered energy from the hot expander may be used to at least partially supply power for other portions of the integration or for other processes.

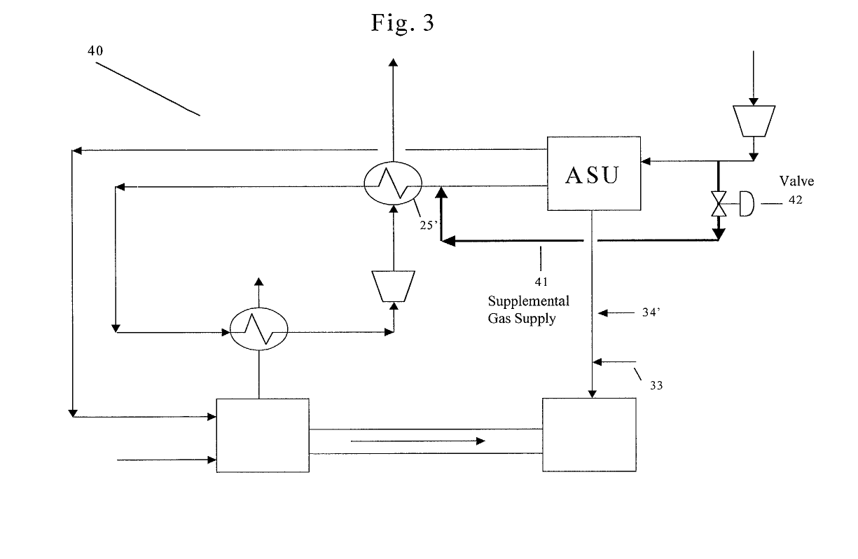

Now referring to FIG. 3, an alternate embodiment of the present invention may be observed wherein additional energy is generated. In this embodiment, power recovery of the process is enhanced by increasing the mass flow of hot gas expander 27. In various embodiments, an air stream or a supplemental gas stream is extracted before ASU 21 and mixed with the first nitrogen stream to increase the mass flow. The mixture is then heated and/or preheated and expanded as heretofore described. Various other embodiments may utilize a different source for a supplemental supply of gas for first nitrogen stream as is common in the art. Other embodiments may feed a supplemental gas supply 41 as needed by regulating an amount and/or volume of gas taken by valve 42. When additional energy is needed, a supplemental flow can be allowed to pass through valve 42. When extra energy is not desired, or when the process dictates a greater supply of gas to ASU 21, flow through valve 42 can be reduced. As well, valve 42 can be configured to allow varying amounts and/or volumes of gas as a supplemental supply.

Power generated by hot expander 27 can be used to drive compressor(s) of ASU 21 or to generate electric power by use of electric generator (not shown) to compensate for the power usage of ASU 21. As indicated above, a second nitrogen rich stream can be optionally produced by ASU 21 to supply nitrogen for the Float Glass-Forming Chamber 8. This second nitrogen stream is characterized by its purity, usually in the parts per million (ppm) of oxygen content. The second nitrogen rich stream is optionally heated, and is mixed with hydrogen 33 to serve as a protective atmosphere for the bath of the float glass-forming chamber, such as a tin bath, preventing the bath metals from being oxidized by traces of oxygen that may be present in the chamber.

In various embodiments, flue gas of melting furnace 5 is at very high temperature (1400-1600° C.) and contains some corrosive compounds like SOx and also some fouling materials. Because of this harsh environment, heater 26 is of a special construction that is able to withstand high temperatures and corrosive environments. In order to minimize the cost of heater 26 and to maximize the amount of heat recoverable from the flue gas, part of its heat transfer duty may be performed in pre-heater 25 as described in FIGS. 2 and 3. Pre-heater 25 is of simpler construction and costs less since it is in contact with cleaner nitrogen gas and lower temperatures.

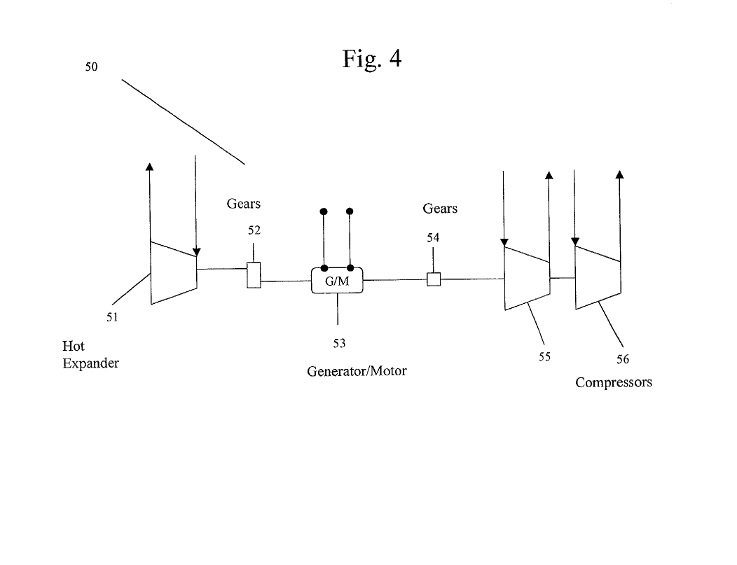

Other design parameters for lowering equipment capital costs and/or operational costs are disclosed in FIG. 4. Integrating the rotating machineries into one single train 50 will reduce total equipment cost. Generally, hot expander 51 can be mechanically attached to the compressors 55, 56, and/or electric motor(s) 53 to simplify the arrangement and to lower the equipment/installation cost. Speed reducing or increasing gears 54, 52 can be optionally used to optimize the train performance. In some cases, an electric generator 53 can also be integrated into the train to balance out the power output of the system. However, other arrangements of a generator, expander and compressors will be readily apparent to those of ordinary skill in the art. It is useful to note that the compressors of the air separation unit such as air compressor and nitrogen product compressors can be optionally combined as a single assembly which is then integrated with the single train of machinery as mentioned above.

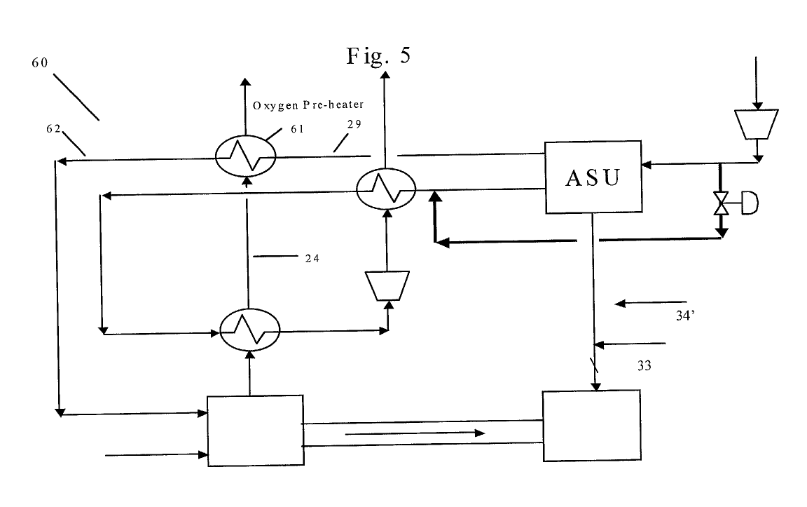

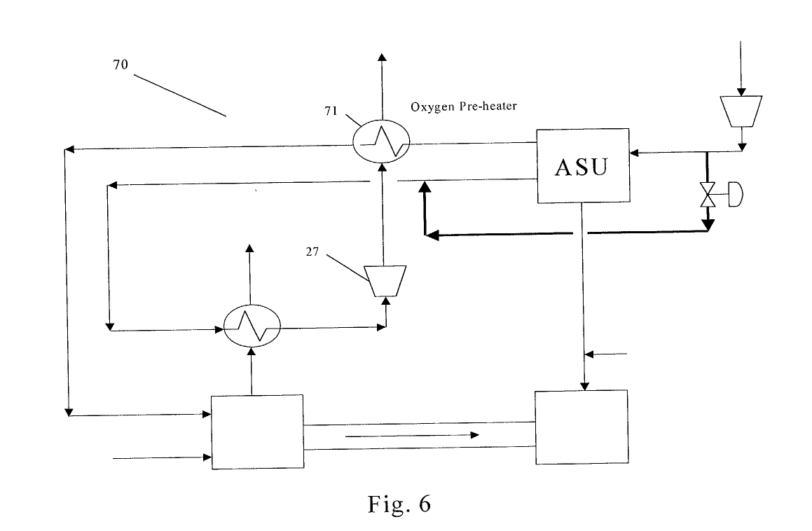

Now referring to FIG. 5, an alternate embodiment of the present invention is disclosed wherein a greater fuel efficiency is realized by pre-heating an oxygen stream prior to introduction to melting furnace 5. System 60 discloses a further use of a flue gas released from melting furnace 5. In this embodiment, at least a portion 24 of flue gas from melting furnace 5 is passed through oxygen pre-heater 61 in heat exchange with oxygen stream 29 extracted from ASU 21 to warm oxygen stream 29 before it is fed to melting furnace 5. However, various processes may be used to pre-heat the oxygen stream. For example, hot gas expander 27 outlet in heater 71 as illustrated in FIG. 6 may be used. Other embodiments of system 70 can use at least a portion of the heat of expander 27 to heat first nitrogen stream, an oxygen stream, or another stream.

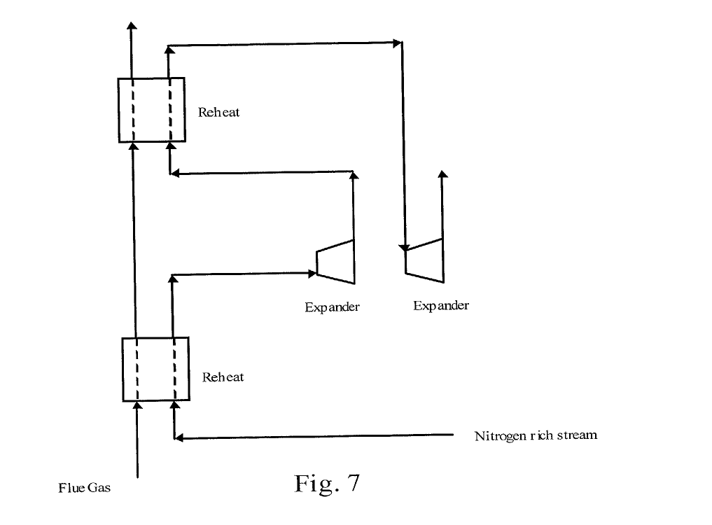

Now referring to FIG. 7, an embodiment of an alternate energy recovery system that can be employed with the various embodiments of the present invention, instead of expanding the hot nitrogen by a single expander one can also perform multiple expansion steps with reheat as illustrated in FIG. 7. A two-step reheat and expansion is illustrated but it is understood that more reheat steps are possible. One advantage of the reheat feature is it allows maximizing the heat recovery process by sending gas through the heating stream in multiple passes. Furthermore, thanks to the more efficient reheat cycle, lower temperature at the inlet of the hot expanders can be utilized to lower the cost of the expanders without sacrificing the thermodynamic efficiency of the cycle.

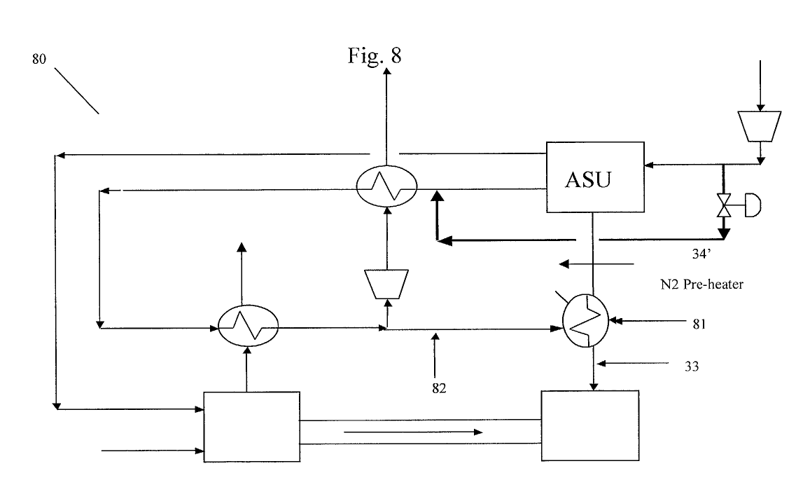

Now referring to FIG. 8, an alternate embodiment of the present invention is illustrated. In system 80, second nitrogen stream 34′ is preheated before being fed to the float glass forming chamber and/or other part of the cooling line where some hot air is also required and can be replaced by hot nitrogen. As U.S. Pat. No. 5,925,158 illustrated, the atmosphere in float glass forming chamber 8 is heated. The protective atmosphere is heated for several reasons, including to cool the molten glass on the tin bath more slowly. Cooling the molten glass more slowly helps prevent stress, cracks, and/or the like in the cooling glass. Accordingly, external heating sources, such as electrical charges and the like are often required to heat the protective atmosphere prior to and/or while the atmosphere is over the float glass. In various embodiments of the present invention, a nitrogen preheater 81 is used. Nitrogen preheater 81 may preheat second nitrogen stream 34′ through heat exchange or any other method common in the art. Various other embodiments to pre-heat second nitrogen stream 34′ will be readily apparent to those of ordinary skill in the art. In an embodiment, at least a portion of preheated first nitrogen stream 82 is heat exchanged in preheater 81 with second nitrogen stream 34′. However, various other process streams and/or other heated streams can be used.

### EXAMPLE

The following table is a comparison of an integrated nitrogen generator producing about 68% by volume oxygen gas with nitrogen product at about 11 bar absolute and a traditional non-integrated double-column ASU producing about 96% oxygen. The nitrogen from the nitrogen generator is heated to 700° C. prior to expansion.

| | Integrated N2 Generator | Non-integrated O2 Plant |
|---|---|---|
| Total Consumed | 162 | 100 |
| Power | | |
| Recovered Power | −134 | 0 |
| Net Power Input | 28 | 100 |
| % reduction of | 72% | 0% |
| power input | | |

Notes:

1. For ease of comprehension, the power consumption of the non-integrated oxygen plant is normalized and taken as 100.

2. The equipment arrangement for this example is as described in FIG. 2.

Therefore, it can be seen from the above numerical example that the power consumption of the oxygen plant can be reduced by about 72% by recovering the waste heat of the furnace of the Float glass facility. The various other modifications for energy recovery are well known and proven in the art and should be additive to the energy savings in this example. Accordingly, the use of a variety of combinations of the energy saving provisions of this disclosure will provide varying levels of energy conservation and/or energy consumption reduction.

I claim:

1. An integrated process of a glass manufacturing facility and an air separation unit, comprising the steps of:
producing at least a first nitrogen stream and an oxygen stream from the air separation unit;
feeding the oxygen stream to a melting furnace of the glass manufacturing facility;
discharging a flue gas from the melting furnace;
heating the first nitrogen stream with the flue gas;
expanding the first heated nitrogen stream; and,
recovering energy from the expansion.

2. The process of claim 1 wherein the flue gas is at a temperature of about 1000 degrees Celsius to about 2000 degrees Celsius.

3. The process of claim 1 wherein the first nitrogen stream is heated by heat exchange with the flue gas.

4. The process of claim 1 further comprising using a low NOx burner in the melting furnace.

5. The process of claim 1 further comprising the step of preheating the first nitrogen stream.

6. The process of claim 1 further comprising the step of mixing additional gas with the first nitrogen stream to increase the mass flow of the first nitrogen stream.

7. The process of claim 1 wherein the glass manufacturing facility is a float glass facility.

8. The process of claim 1 wherein the step of expanding the 1^{st} nitrogen stream is mechanically attached to at least one of a compressor, electric motor, and a gear, on a single train.

9. The process of claim 1 wherein the oxygen stream is preheated before feeding to the melting furnace.

10. The process of claim 1 further comprising at least one step of heating and expanding the expanded first nitrogen stream.

11. The process of claim 4 wherein the glass manufacturing plant is a float glass facility.

12. The process of claim 11 further comprising the step of mixing additional gas with the first nitrogen stream to increase the mass flow of the first nitrogen stream.

13. The process of claim 11 further comprising extracting a second nitrogen stream from the air separation unit and feeding to a float glass forming chamber of the float glass facility.

14. The process of claim 13 further comprising mixing a hydrogen stream with the second nitrogen stream.

15. The process of claim 14 further comprising preheating the second nitrogen stream.

16. An integrated system of a glass manufacturing facility and an air separation unit comprising:
a glass manufacturing facility comprising a melting furnace and a flue gas vent; and an air separation unit, wherein a first nitrogen stream is extracted from the air separation unit, heat exchanged with a flue gas from the flue gas vent, and hot expanded whereby energy is recovered from the hot expansion.

17. The system of claim 16 further comprising means for increasing the mass flow of the first nitrogen stream.

18. The system of claim 16 further comprising a pre-heater to pre-heat at least one of the the first nitrogen stream, an oxygen stream extracted from the air separation unit and fed to the melt furnace, and a second nitrogen stream extracted from the air separation unit and fed to a float glass forming chamber of the glass manufacturing facility.

19. The system of claim 16 further comprising extracting an oxygen stream from the air separation unit and feeding the oxygen stream to the melting furnace.

20. The system of claim 16 wherein the glass manufacturing facility is a float glass facility.

21. The system of claim 16 further comprising a low NOx burner in the melting furnace.

22. An integrated process of a glass manufacturing facility and an air separation unit comprising the steps:
extracting a first nitrogen stream from the air separation unit;
releasing a flue gas from the glass manufacturing facility;
heat exchanging the flue gas with the first nitrogen stream;
expanding the first nitrogen stream to recover energy.

23. The process of claim 22 further comprising extracting an oxygen stream from the air separation unit and feeding the oxygen to a melting furnace of the glass manufacturing facility.

24. The process of claim 22 further comprising preheating at least one of the first nitrogen stream and an oxygen stream extracted from the air separation unit.

25. The process of claim 22 further comprising increasing the mass flow of the first nitrogen stream.

26. The process of claim 22 further comprising reheating the first nitrogen stream.

27. The process of claim 22 further comprising using a low NOx burner in the melting furnace.

28. The process of claim 22 wherein the glass manufacturing facility is a float glass facility.

29. The process of claim 28 further comprising the step of pre-heating a second nitrogen stream extracted from the air separation unit and fed to at least one of the float glass forming chamber and the cooling line of the float glass facility.
